(19) United States
(12) Patent Application Publication
(10) Pub. No.: US 2024/0045913 A1
(43) Pub. Date: Feb. 8, 2024

(54) SYSTEMS AND METHODS FOR ACTIVE WEB-BASED CONTENT FILTERING

(71) Applicant: Capital One Services, LLC, McLean, VA (US)

(72) Inventors: Abdelkader BENKREIRA, Washington, DC (US); Brendan WAY, Brooklyn, NY (US); Xiaoguang ZHU, New York, NY (US)

(21) Appl. No.: 17/880,443

(22) Filed: Aug. 3, 2022

(51) Int. Cl. G06F 16/9535; G06F 40/205; G06F 40/30

(52) U.S. Cl. CPC G06F 16/9535; G06F 40/205; G06F 40/30

(57) ABSTRACT

Systems and methods for active web-based content filtering may include a memory storing user restrictions and dislikes, an interface, and a processor communicatively coupled to a backend server. The processor may implement a web browser add-on that parses content from an incoming webpage and compares that content against the user restrictions and dislikes to determine undesired incoming webpage content, and create a filtered webpage by removing the undesired incoming webpage content, and display the filtered webpage to the user.

### FIELD OF THE DISCLOSURE

The present disclosure relates to systems and methods for active web-based content filtering.

### BACKGROUND

There is a plethora of information available on the Internet. However, more is not always better. It can often be cumbersome and inefficient to parse and search multiple webpages for desired information, content, products, images, etc. Smaller screen sizes on devices such as smart phones, wearables, iPads, and the like, tend to exacerbate the difficulties associated with searching through webpages for specific content

These and other deficiencies exist. Accordingly, there is a need for streamlining webpages in a way that makes user interaction with those webpages more rewarding and efficient.

### SUMMARY OF THE DISCLOSURE

Embodiments of the present disclosure provide an active web-based content filtering system. The active web-based content filtering system may include a memory, an interface, and a processor communicatively coupled to a backend server. The memory may be configured to store a user restrictions file received from the backend server, the user restrictions file comprising one or more user dislikes. The processor may be configured to implement a web browser add-on that receives an incoming webpage based on a user input, parse content from the incoming webpage using natural language processing and a semantics engine to derive understanding and context from the parsed content, request, over a network, the user restrictions file from the backend server, receive the user restrictions file, extract the one or more user restrictions and/or dislikes from the user restrictions file, determine undesired incoming webpage content by comparing each of the extracted user restrictions and dislikes with the parsed content from the incoming webpage to determine if each user restriction or dislike directly or indirectly matches the extracted content, where a direct match relies similarity of words and an indirect match is based on contextual relationships between words, create a filtered webpage by removing the undesired incoming webpage content, and display the filtered webpage to the user.

Embodiments of the present disclosure provide a method for active web-based content filtering. The method may include receiving, by a processor, an incoming webpage based on a user input, parsing, by the processor, content from the incoming webpage using natural language processing and a semantics engine to derive understanding and context from the parsed content, requesting, over a network, a user restrictions file from a backend server, the user restrictions file comprising one or more user dislikes, receiving, by the processor, the user restrictions file, extracting the one or more user restrictions and/or dislikes from the user restrictions file, determining, by the processor, undesired incoming webpage content by comparing each of the extracted user restrictions and dislikes with the parsed content from the incoming webpage to determine if each user restriction or dislike directly or indirectly matches the extracted content, where a direct match relies similarity of words and an indirect match is based on contextual relationships between words, creating, by the processor, a filtered webpage by removing the undesired incoming webpage content; and displaying, by the processor, the filtered webpage to the user.

Embodiments of the present disclosure provide a computer readable non-transitory medium comprising computer-executable instructions that are executed on a processor and comprising the steps of: receiving, by a processor, an incoming webpage based on a user input, parsing, by the processor, content from the incoming webpage using natural language processing and a semantics engine to derive understanding and context from the parsed content, requesting, over a network, a user restrictions file from a backend server, the user restrictions file comprising one or more user dislikes, receiving, by the processor, the user restrictions file, extracting the one or more user restrictions and/or dislikes from the user restrictions file, determining, by the processor, undesired incoming webpage content by comparing each of the extracted user restrictions and dislikes with the parsed content from the incoming webpage to determine if each user restriction or dislike directly or indirectly matches the extracted content, where a direct match relies similarity of words and an indirect match is based on contextual relationships between words, creating, by the processor, a filtered webpage by removing the undesired incoming webpage content; and displaying, by the processor, the filtered webpage to the user.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Various embodiments of the present disclosure, together with further objects and advantages, may best be understood by reference to the following description taken in conjunction with the accompanying drawings.

FIG. 1 illustrates an active web-based content filtering system according to an exemplary embodiment.

FIG. 2 illustrates a sequence of operations for actively filtering content from a webpage according to an exemplary embodiment.

FIG. 3 illustrates a sequence of operations for actively filtering content from a webpage including applying and training a machine learning algorithm to enable the active filtering according to an exemplary embodiment.

FIG. 4 is a schematic representation of a user device usable in embodiments of the invention.

FIG. 5 is a schematic representation of a backend usable in embodiments of the invention.

FIG. 6 is a schematic representation of a machine learning algorithm module within the backend, usable in embodiments of the invention.

FIG. 7 is a flow diagram illustrating a method of actively filtering content from a webpage according to an embodiment of the invention.

FIG. 8 is a flow diagram illustrating a method of actively filtering content from a webpage including applying and training a machine learning algorithm to enable the active filtering according to an embodiment of the invention.

### DETAILED DESCRIPTION

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The present invention provides systems and methods by which a user device in communication with backend and a web host may filter a webpage from the web host by removing undesired content prior to displaying that webpage to a user. This may be accomplished by comparing a list of user restrictions and dislikes against the content of the webpage and then removing webpage content that forms the basis of a user restriction or dislike.

The systems and methods for actively filtering content from a webpage improve the interactive user experience by reducing the amount of time a user is searching for desired content and improving the odds that the user finds the desired content. By providing these benefits to users, over time user engagement with these systems and methods will increase, thereby leading to the opportunity for ever improving and more valuable systems and methods.

Further, the systems and methods for actively filtering content from a webpage promotes system efficiency by performing filtering at the local, user device level, thereby reducing processing loads on web hosts to provide customized user content. Additionally, training a machine learning algorithm to predict user restrictions and dislikes reduces the demands on backend systems over time to improve the functioning of computers and conserve system resources.

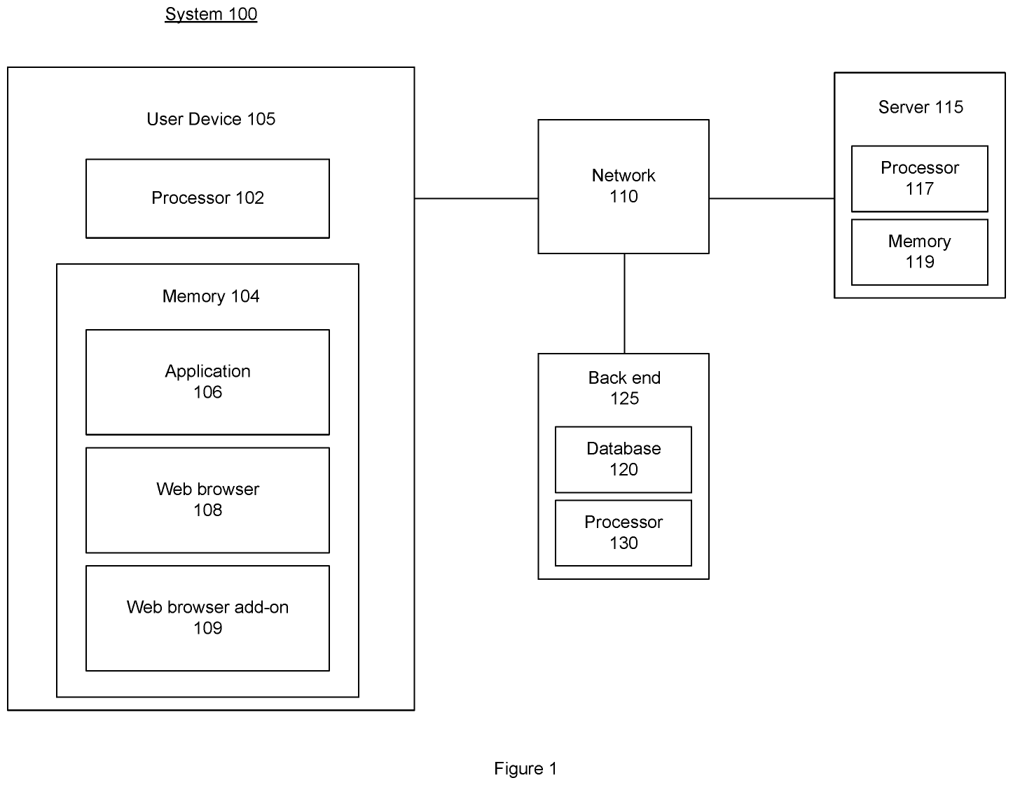

FIG. 1 illustrates an active web-based content filtering system 100. The system 100 may comprise may include a device 105, a network 110, a server 115, and a backend 125. Although FIG. 1 illustrates single instances of components of system 100, system 100 may include any number of components.

System 100 may include a device 105. The device 105 may include one or more processors 102 and memory 104. Memory 104 may include one or more applications, such as application 106 as well as web browser 108 and web browser add-on 109. The device 105 may be in data communication with any number of components of system 100. For example, the device 105 may transmit data via network 110 to server 115. The device 105 may transmit data via network 110 to backend 125 which may include database 120 and processor 130. Web browser 108 may send requests to server 115 for webpages and may receive one or more webpages from server 115. Web browser add-on 109 may run in conjunction with web browser 108 and may intercept any webpages from server 115. Web browser add-on may be in communication with application 106 and may request and receive data from application 106 including a list of a user's dislikes. The list of user dislikes may be stored on device 105 or may be stored in database 120 and application 106 may access the list of user's dislikes in database 120, through network 110. Without limitation, the device 105 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device. The device 105 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The device 105 may include processing circuitry and may contain additional components, including processors, memories, error and parity/CRC checkers, data encoders, anticollision algorithms, controllers, command decoders, security primitives and tamper-proofing hardware, as necessary to perform the functions described herein. The device 105 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include a network 110. In some examples, network 110 may be one or more of a wireless network, a wired network or any combination of wireless network and wired network, and may be configured to connect to any one of components of system 100. For example, the device 105 may be configured to connect to server 115 via network 110. In some examples, network 110 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network 110 may include, without limitation, telephone lines, fiber optics, IEEE Ethernet 902.3, a wide area network, a wireless personal area network, a LAN, or a global network such as the Internet. In addition, network 110 may support an Internet network, a wireless communication network, a cellular network, or the like, or any combination thereof. Network 110 may further include one network, or any number of the exemplary types of networks mentioned above, operating as a stand-alone network or in cooperation with each other. Network 110 may utilize one or more protocols of one or more network elements to which they are communicatively coupled. Network 110 may translate to or from other protocols to one or more protocols of network devices. Although network 110 is depicted as a single network, it should be appreciated that according to one or more examples, network 110 may comprise a plurality of interconnected networks, such as, for example, the Internet, a service provider's network, a cable television network, corporate networks, such as credit card association networks, and home networks.

System 100 may include one or more servers 115. In some examples, server 115 may include one or more processors 117 coupled to memory 119. Server 115 may be configured as a central system, server or platform to control and call various data at different times to execute a plurality of workflow actions including displaying one or more webpages. Server 115 may be configured to connect to device 105. Server 115 may be in data communication with the application 106 and the web browser 108. For example, a server 115 may be in data communication with application 106 and the web browser 108 via one or more networks 110. The device 105 may be in communication with one or more servers 115 via one or more networks 110. The device 105 may transmit, for example from web browser 108 executing thereon, one or more requests for a webpage to server 115. Server 115 may receive the one or more requests from device 105. Based on the one or more requests from web browser 108, server 115 may be configured to return the requested webpage. Server 115 may be configured to transmit the requested webpage to the web browser 108.

In some examples, server 115 can be a dedicated server computer, such as bladed servers, or can be personal computers, laptop computers, notebook computers, palm top computers, network computers, mobile devices, wearable devices, or any processor-controlled device capable of supporting the system 100. While FIG. 1 illustrates a single server 115, it is understood that other embodiments can use multiple servers or multiple computer systems as necessary or desired to support the users and can also use back-up or redundant servers to prevent network downtime in the event of a failure of a particular server.

Server 115 may include an application in memory 119 comprising instructions for execution thereon. For example, the application may comprise instructions for execution on the server 115. The application may be in communication with any components of system 100. For example, server 115 may execute one or more applications that enable, for example, network and/or data communications with one or more components of system 100 and transmit and/or receive data. Without limitation, server 115 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. Server 115 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 115 may include processing circuitry and may contain additional components, including processors, memories, error and parity/CRC checkers, data encoders, anticollision algorithms, controllers, command decoders, security primitives and tamper-proofing hardware, as necessary to perform the functions described herein. The server 115 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

System 100 may include one or more databases 120. The database 120 may comprise a relational database, a non-relational database, or other database implementations, and any combination thereof, including a plurality of relational databases and non-relational databases. In some examples, the database 120 may comprise a desktop database, a mobile database, or an in-memory database. Further, the database 120 may be hosted internally by any component of system 100, such as the device 105 or server 115, or the database 120 may be hosted externally to any component of the system 100, such as the device 105 or server 115, by a cloud-based platform, or in any storage device that is in data communication with the device 105 and server 115. In some examples, database 120 may be in data communication with any number of components of system 100. For example, the processor 102 in data communication with the application 106 may be configured to transmit one or more requests for the requested data from database 120 via network 110.

In some examples, exemplary procedures in accordance with the present disclosure described herein can be performed by a processing arrangement and/or a computing arrangement (e.g., computer hardware arrangement). Such processing/computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of the device 105, server 115, and/or database 120, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

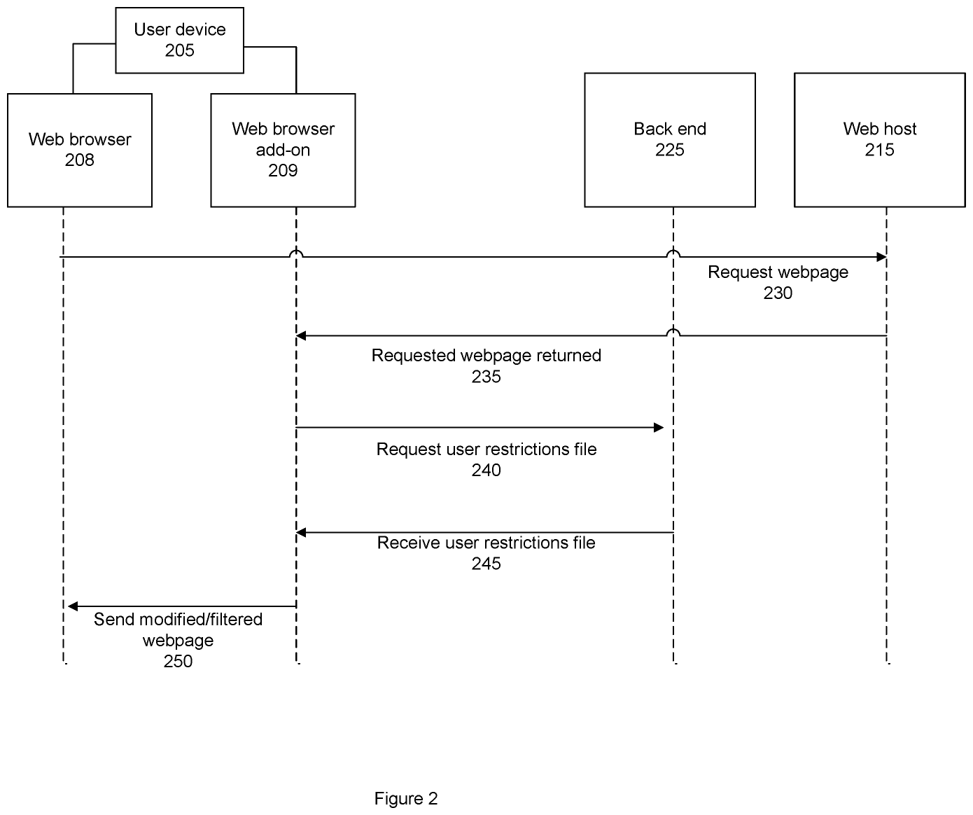

The sequence diagram of FIG. 2 illustrates an exemplary application of embodiments of the invention in conjunction with the system 100 of FIG. 1. In the scenario set forth in FIG. 2, a user device 205 is in communication with a web host 215 and backend 225. User device 205 may a personal computer, smart phone, smart watch, or any other network enabled computing device. User device 205 may include memory, a network communication, an interactive user interface, and a processor capable of running one or more software applications, including web browser 208 and web browser add-on 209. Both web browser 208 and web browser add-on 209 may be in direct communication with web host 215. Web browser add-on 209 may run in conjunction with the web browser and may modify the function of the web browser. The web host 215 may host a webpage on the world wide web, including commerce webpages such as Amazon.com or Walmart.com, informational webpages such as CNN.com, and social media webpages such as Facebook.com. Web host 215 may comprise a server, and include a memory, a processor, and a network communication. Backend 225 may include a database capable of storing user transaction data, social media data, and other data that may indicate one or more user restrictions. Backend 225 may also include a processor capable of implementing machine learning algorithms.

A user, through user device 205, may attempt to access a webpage on web browser 208. A request for the desired webpage may be sent from user device 205, through web browser 208, to web host 215 at 230. The web host 215 may receive the request and in return, send the requested webpage to user device 205 at 235. The webpage sent from web host 215 may be intercepted by web browser add-on 209 before reaching web browser 208 and being displayed on user device 205. Web browser add-on 209 may then send a request to backend 225 for a user restrictions file at 240. The user restrictions file may include one or more extractable user restrictions and/or user dislikes. The user restrictions file may be formatted in a number of ways. For instance, the user restrictions file may comprise a list of user restrictions and/or user dislikes in a known or standardized layout (i.e. structured data) for simplicity of extraction. The user restrictions file may also comprise executable code, such as SQL statements or the like, that reference databases that store restrictions data for a pool of users. The code may direct to the correct areas of one or more databases to retrieve the restrictions and/or dislikes data for the given user. The user restrictions and/or user dislikes in the user restrictions file may be the result of the user entering those restrictions and dislikes through an application associated with backend 225, via the interactive user interface of user device 205. The user restrictions and/or user dislikes may also be the result of one or more predictions made by the backend processor implementing one or more machine learning algorithms to predict one or more user restrictions and/or user dislikes. The machine learning algorithm may include user entered restrictions and dislikes as inputs to the algorithm(s). The one or more machine learning algorithms may also use other data stored in the backend database as inputs, this may include historical user transaction data and social media data from the user, a plurality or users, and/or a plurality of similarly situated users. A user restrictions file, responsive to the request from web browser add-on 209, may be returned from backend 225 to web browser add-on 209 at 245.

Web browser add-on 209 may parse the intercepted webpage and the received user restrictions file. Parsing of the intercepted webpage may include processing that webpage to determine and recognize language, numbers, and images. The recognized language may include products and product descriptions, while the numbers may include pricing and/or product rankings, stock-keeping units (SKUs) or any other numbering associated with products on a commercial webpage. Images may include product images or branding and may include recognition of words within images, or recognition of products from within images. Parsing of the restrictions file may include processing the file to recognize and extract a list of specific restrictions and/or dislikes associated with the user. Web browser add-on 209 may then compare the parsed webpage with the extractions from the parsed user restrictions file to determine any overlap or matches between the content in the user restrictions file and content on the parsed webpage. The comparison performed by web browser add-on 209 may include taking each discrete user restriction or dislike from the user restrictions file and search for that discrete restriction or dislike in the parsed content from the webpage. The comparison may detect direct matches between user restrictions or dislikes and content on the parsed webpage. The comparison may also detect indirect matches based on lexical semantics and understanding imposed by the web browser add-on 209. The indirect matches may include degrees of logical separation from direct word matches, or matches that are tangentially related. For example, if a user restriction includes a nut allergy, then an indirect match may include the system detecting a product containing peanuts and understanding that a peanut is a type of nut and is related to nut allergies. Another example is if a user dislikes the color blue and a listing on a webpage includes a product that is “aqua,” then web-browser add-on 209 may conclude that “aqua” is a shade of blue and therefore is an indirect match. Web browser add-on 209 may then filter that parsed webpage by removing all content that directly or indirectly matches restrictions or dislikes in the user restrictions file. Once removed, the web browser add-on 209 may leave the filtered webpage with blanks where the filtered content was originally, or may reformat the filtered webpage so that there are no blank spaces in the filtered webpage. One benefit to leaving the filtered webpage in its original format is that a user may see the blank spaces and appreciate that content was removed by web browser add-on 209. If the user is interested to see and understand what content was removed from view, the user may disable web browser add-on 209 and see the unfiltered webpage, and know where to look for the content that was removed by web browser add-on 209. Another benefit to leaving the webpage in its original format is that this approach is less taxing to a processor for user device 205. A benefit to reformatting the filtered webpage is that there is no “dead space,” leading to a more seamless user experience, and a user may not have to scroll as far to see remaining content on the webpage. This approach generally provides a more pleasing user experience, but may not provide any indication to the user that content has been removed or filtered from the requested webpage or the amount or frequency of such content removal.

Once web browser add-on 209 has filtered the webpage, the filtered webpage is sent to web browser 208 for display to the user, on user device 205 via the interactive user interface at 250.

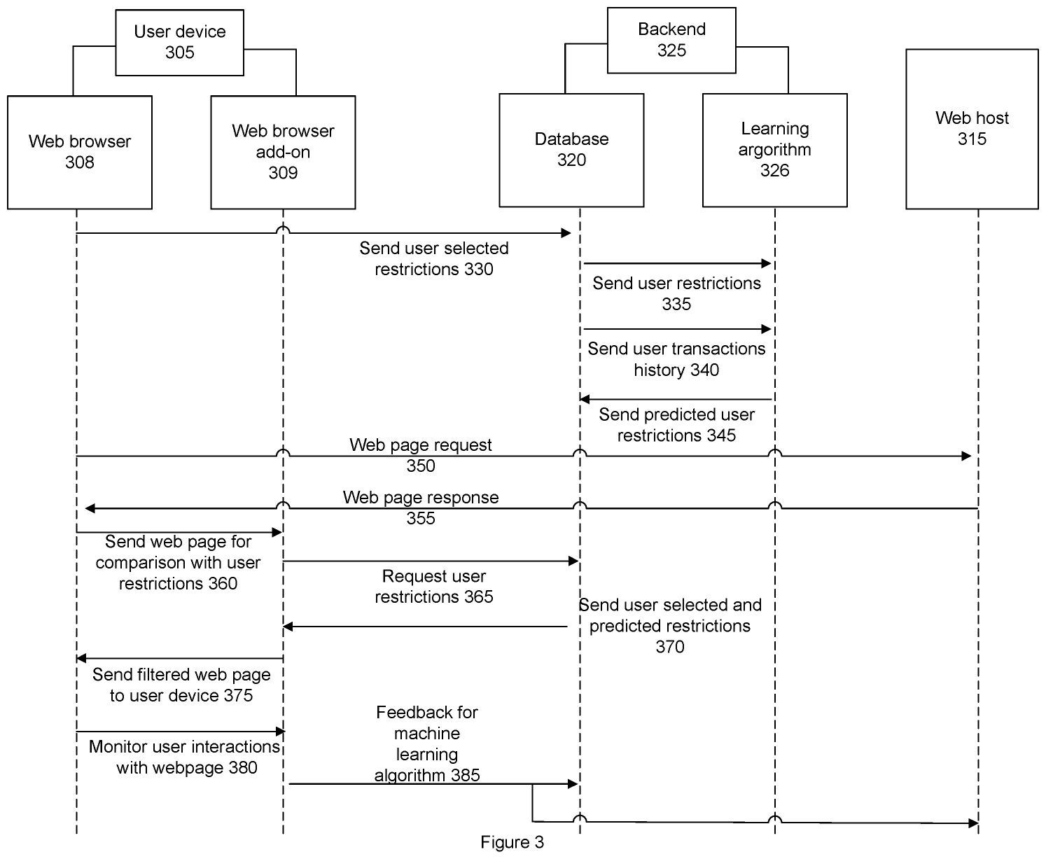

In some embodiments, it may be desirable to implement a machine learning algorithm to predict one or more user restrictions or dislikes. This approach would allow for adaptation of the system over time to meet a user's changing restrictions and/or dislikes without requiring the user to update his or her stated restrictions and dislikes for the user restrictions file. The sequence diagram of FIG. 3 illustrates an exemplary scenario in which the backend fully employs a machine learning algorithm in connection with a web-based content filtering system.

A user may interact with an application on a user device. The application may be communicatively coupled with a backend for the application via a communication interface on user device 305. The application may be an application associated with a financial entity or some other entity. The application may require user login and may track one or more user financial accounts. A user may be prompted to enter a list of restrictions such as dietary restriction, religious restrictions, physical restrictions, medical restrictions, etc. The user may also be prompted to enter a list of dislikes. These dislikes may include any foods, food ingredients such as gluten, nuts, etc., food types such as organic, not organic, etc., classes of food such as seafood, sushi, etc., or any other classification or delineation of food products. Non-food related product dislikes may include colors, materials such as denim or spandex for clothing, specific product brands, types and/or classes of products, product formats such as digital downloads vs. physical copies of media, etc. The dislikes may also extend beyond goods and services to include religion, politics, news topics, people, or any other type of potential user dislike. The backend 325 may include a database 320 and a processor capable of implementing a machine learning algorithm.

The user-entered list of restrictions and dislikes may be packaged into a user restrictions file by the application running on the user device 305, and may be sent to database 320 of backend 325 at 330. Backend 325 may store the user restrictions file in database 320. Backend 325 may also send the user restrictions file from database 320 to the machine learning algorithm 326 at 335. Backend 325 may also store historical user transaction data. The historical user transaction data may comprise a history of user transactions completed with one or more accounts associated with the financial entity that owns the application. In instances where the application is owned by a non-financial entity, the non-financial entity may maintain a database that includes a history of user transactions completed with one or more accounts for which the respective financial entities for those one or more accounts have provided the historical transaction data or have provided access to transaction data maintained on the financial entities' databases. Backend 325 may store historical user transaction data for each of its users, thereby comprising a large group of consumer transaction history. At 340, backend 325 may send the historical user transaction data to the machine learning algorithm. In one embodiment, the machine learning algorithm may also receive the large group of consumer transaction history as a discrete input to the machine learning algorithm 326. In some embodiments, the machine learning algorithm may receive additional inputs such as user data scraped from social media websites or other social media interfaces. The scrapped user data from social media may include posts made by the user, responses to posts made by others, discussions including the user, user likes, user dislikes, user interaction with social media content, lack of user interaction with social media content, etc.

Machine learning algorithm 326 may then use the received data to determine one or more additional restrictions and/or dislikes. The machine learning algorithm may predict one or more relationships between products and user stated restrictions or dislikes. For instance, a k-nearest neighbors (“KNN”) algorithm may be used associate and cluster similar products and product features, characteristics, ingredients, etc. For example, gummy candies may be grouped together to include gummy bears, gummy worms, gummies, etc. Then specific ingredients such as sugar, food coloring, etc. or characteristics such as “candy,” “soft,” “sweet,” etc. may be associated with the cluster. Furthermore, clusters may be linked through common ingredients, characteristics, or other commonalities. By way of example, the machine learning algorithm may predict that if a user dislikes gummy bears, he or she will also dislike soft cookies, oatmeal, soda with a common food coloring, etc. The machine learning algorithm may also rely on stated dislikes and restrictions from other users in conjunction with a user restriction file to help predict user dislikes and restrictions for a given user. Machine learning algorithm 326 may utilize a system of weights and ranks for the predictions based on a confidence in the prediction. The confidence in a prediction may be based on the number of commonalities of characteristics, ingredients, etc. to a user stated restriction or dislike, or based on affirming feedback based on one or more prior predictions. Machine learning algorithm 326 may be trained to better predict user dislikes and restrictions by analyzing across all users.

Once the machine learning algorithm 326 has predicted one or more additional restrictions and/or user dislikes, at 345 those predicted restrictions and/or dislikes are sent to database 320 for inclusion with the user restrictions file. Backend 325 may create an updated restrictions file that may include both the user selected restrictions and/or dislikes as well as the machine learning algorithm's 326 predicted restrictions and/or dislikes. The updated restrictions file may be stored in database 320.

At 350, a user may interact with a web browser on user device 305 to navigate to a webpage on the Internet. The user interaction of attempting to navigate to an Internet webpage may result in a webpage request being sent at 350, to web host 315. Web host 315 may be a server and include a processor, memory, and a network communications interface. Web host may receive the webpage request at 350 and send a webpage response that may include the requested webpage at 355. The webpage response may be sent to web browser 308 via device 305. In an alternate embodiment, the webpage response may be sent to web browser add-on 309. Prior to displaying the requested webpage to the user via the interactive user display of user device 305, web browser 308 may send the requested webpage to web browser add-on 309 for comparison with the updated user restrictions file at 360. At 365, web browser add-on 309 may send a request to database 320, via backend 325, for the user restrictions file associated with the user of user device 305. At 370, backend 325 may return the requested user restrictions file from database 320 to web browser add-on 309. The requested user restriction file returned from backend 325 may be the updated user restriction file and may include both the user designated restrictions and/or dislikes as well as the predicted user restrictions and/or dislikes.

Web browser add-on 309 may parse the requested webpage as well as the updated user restrictions file. Parsing of the requested webpage may include processing the requested webpage to determine and recognize content. That content may include natural language, product listings, pricing information, product SKUs, product images, branding including trademarks and service marks, etc. The recognized natural language may include product descriptions and other textual material. Product images may include images of actual products, words that identify products within an image, branding, including trademarks and/or service marks within an image, etc. Parsing of the updated user restrictions file may include processing the file to recognize and extract a list of specific restrictions and/or dislikes associated with the user. The list of specific user restriction and/or dislikes may be distinguished by user stated restrictions and/or dislikes and predicted user restrictions and/or dislikes. Web browser add-on 309 may implement a system of weights and ranks to the updated user restrictions file where user identified restrictions and/or dislikes are provided more or less weight than predicted restrictions and/or dislikes. Web browser add-on may disregard restrictions or dislikes that fall below a threshold ranking or value. In one embodiment, the threshold ranking or value may be set based on a setting internal to web browser add-on 309. In another embodiment the threshold ranking or value may be set based on a user selection of filtering sensitivity in one of the application or the web browser add-on 309.

Web browser add-on 309 may then compare the parsed webpage with the parsed updated user restrictions file to determine any overlap or matches between the included content in the user restrictions file and content on the parsed webpage. The comparison performed by web browser add-on 309 may include taking each discrete stated and predicted user restriction or dislike that was not disregarded by web browser add-on 309 from the user restrictions file and searching for that discrete restriction or dislike in the parsed content from the webpage. The comparison may detect direct matches between user restrictions or dislikes and content on the parsed webpage. For example, the comparison may find gummy bears in the user restrictions file and then find one or more product listings for various types of gummy bears on the request webpage. The comparison may determine this is a direct match. The comparison may also detect indirect matches based on lexical semantics and understanding imposed by web browser add-on 309. The indirect matches may include degrees of logical separation from direct word matches, or matches that are tangentially related. For example, if a user restriction includes a nut allergy, then an indirect match may include web browser add-on 309 detecting a product containing peanuts and understanding that a peanut is a type of nut and is therefore related to nut allergies. The comparison may determine this is an indirect match. Another example is if a user dislikes the color blue and a listing on a webpage includes a product that is “aqua,” then web-browser add-on 309 may conclude that “aqua” is a shade of blue and therefore is an indirect match. Web browser add-on 309 may then filter the parsed requested webpage by removing all content that directly or indirectly matches restrictions or dislikes in the updated user restrictions file. Once removed, web browser add-on 309 may leave the filtered webpage with blanks where the filtered content was originally, or may reformat the filtered webpage so that there are no blank spaces in the filtered webpage. One benefit to leaving the filtered webpage in its original format is that a user may see the blank spaces and appreciate that content was removed by web browser add-on 309. If the user is interested to see and understand what content was removed from view, the user may disable web browser add-on 309 and see the unfiltered webpage, and know where to look for the content that was removed by web browser add-on 309 based on the blank spaces. Another benefit to leaving the webpage in its original format is that this approach is less taxing to a processor for user device 205. A benefit to reformatting the filtered webpage is that there is no “dead space,” leading to a more seamless user experience, and a user may not have to scroll as far to see remaining content on the webpage. This approach generally provides a more pleasing user experience, but may not provide any indication to the user that content has been removed or filtered from the requested webpage or the amount or frequency of such content removal. By removing content from the requested webpage in accordance with the description above, web browser add-on 309 creates a filtered webpage.

Once web browser add-on 309 has filtered the webpage, the filtered webpage is sent to web browser 308 for display to the user on user device 305 via the interactive user interface at 375.

Once the filtered webpage is displayed to the user on user device 305, via the interactive user display, the user may interact with the filtered webpage. The interactions may include selecting various goods or services by clicking on those goods or services. User interactions may also include a user scrolling past results and possibly clicking on subsequent pages without selecting goods or services displayed on the filtered webpage. User interactions may further include user engagement which may be measured by the time spent viewing any portion of the filtered webpage and/or hovering a mouse over an area of the webpage such as hovering over a product or service. These user interactions may take place within web browser 308 and may be collected and sent to web browser add-on 309 at 380. In another embodiment, web browser add-on 309 may monitor and record the user interactions. Web browser add on 309 may, in turn at 385, send the collected user interactions to backend 325. Backend 325 may store this user interactions data in database 320 and also send the data to machine learning algorithm 326 as feedback to train, further refine, and improve the machine learning algorithm. The user interactions data may help train machine learning algorithm 326 in a variety of different ways. For example, if a user selects one or more products from the filtered webpage and then completes a purchase of one or more of those products, the algorithm may infer that the predictions of dislikes and/or restrictions was accurate. However, user interactions that tend to indicate dissatisfaction, such as low user engagement with the filtered webpage, scrolling through the webpage or accessing additional pages in a listing of products (i.e., a desired product was not one of the first results in the filtered webpage). If the filtered webpage is delivered to the user without reformatting (i.e., with blank spaces where removed content was initially) and the user seeks to view the removed content, then this may also be inferred as negative feedback. In another embodiment, viewing the removed content may be inferred as neutral, but it a user then selects a product that was filtered, that data may be inferred as negative feedback. The foregoing are examples of how the user interaction data may be used as feedback to the machine learning algorithm and are not meant to be exhaustive.

With continued feedback and training of the machine learning algorithm over time, the machine learning algorithm may not only become more accurate, but also more efficient as there is less computing necessary as the machine learning algorithm becomes more confident of restrictions and dislikes predictions. Thus, not only is the accuracy of the predictions improved over time, but the functioning of the computer is also improved over time as the machine learning algorithm is trained.

Details of system components usable in embodiments of the invention and, in particular, the system 100 will now be described.

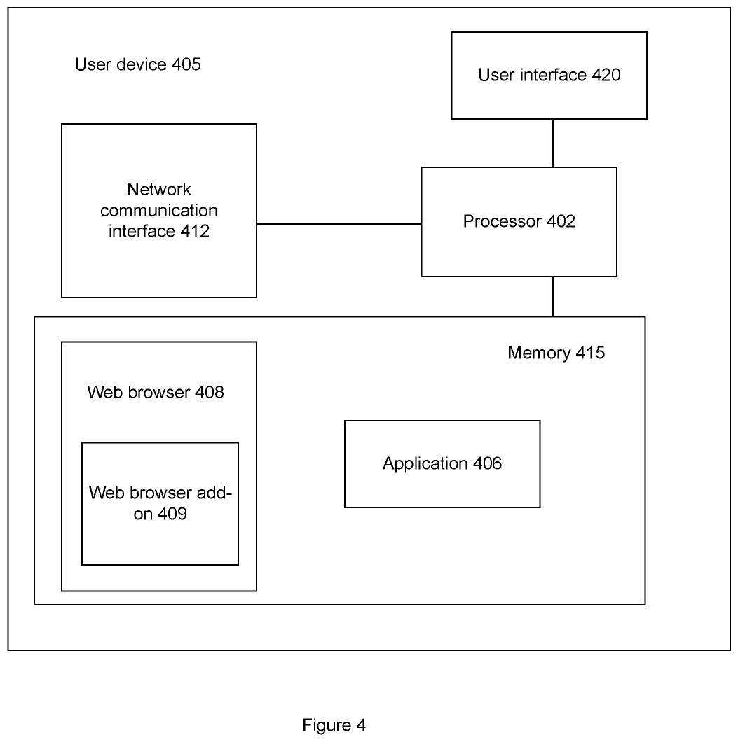

With reference to FIG. 4, user device 405 may be any computer device or communications device including a server, a network appliance, a personal computer (PC), a workstation, and a mobile interface device such as a smart phone, smart watch, smart pad, handheld PC, or personal digital assistant (PDA). In a particular embodiment illustrated in FIG. 4, user device 405 includes an on-board processor 402 in communication with a memory module 415, a user interface 420, and a network communication interface 412. The processor 402 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The memory 415 can be a read-only memory, write-once read-multiple memory or read/write memory, e.g., RAM, ROM and EEPROM, and the user device 405 can include one or more of these memories.

The user interface 420 of the device 405 includes a user input mechanism, which can be any device for entering information and instructions into the user device 405, such as a touch-screen, keyboard, mouse, cursor-control device, microphone, stylus, or digital camera. The user interface 420 may also include a display, which can be any type of device for presenting visual information such as a computer monitor, a flat panel display, and a mobile device screen, including liquid crystal displays, light-emitting diode displays, plasma panels, and cathode ray tube displays.

The network communication interface 412 is configured to establish and support wired and/or wireless data communication capability for connecting the user device 405 to the network 110 or other communication network. The network communication interface 412 can also be configured to support communication with a short-range wireless communication interface, such as Bluetooth.

In embodiments of the invention, the memory 415 may have stored therein application 406 usable by the processor 402. Application 406 may include instructions usable by the processor 402 to register a user, receive user restrictions and/or dislikes, as well as link to one or more user accounts.

Web browser 408 may be stored in memory 415 and instituted by processor 402. Web browser 408 may constitute any user interface with the Internet. Common web browsers include Chrome, Explorer, and Safari. Web browser add-on 409 runs in conjunction with web browser 408 and may override, change, or modify certain aspects of web browser 408. These aspects may include modifying the normal operation of web browser 408 by changing commands, intercepting data including received webpages, and modifying data before relinquishing that data to web browser 408 (e.g., modifying the content and/or appearance of a webpage). In some embodiments, web browser add-on 409 may be in direct communication with application 406.

As a user launches application 406, the application 406 may prompt the user to install web browser add-on 409. If the user accepts, application 406 causes processor 402 to install web-browser 409 on top of a user-selected web browser 408. Application 406 may further prompt the user for a list of restrictions and/or dislikes on the user interface 420. The user may enter these restrictions and dislikes through user interface 420, and application 406 may package these restrictions and/or dislikes into a user restrictions file and store this file locally in memory 415. The application may also send the restrictions file to a backend associated with the application. The restrictions file may travel to the backend over a network, via the network communication interface 412.

A user may further interact with web browser 408 by attempting to visit a webpage. The user may enter in a URL for the desired webpage, or click a link, from a Google search for instance, that navigates to a desired webpage. Web browser 408 may send the user's webpage request over network 110, via network communication interface 412, to a server comprising a web host for the requested webpage. The web browser 408 may receive, via network communication interface 412, the requested webpage from the web host. Web browser 408 may transfer the received webpage to web browser add-on 409 prior to displaying the received webpage to the user. In another embodiment, web browser add-on 409 may intercept the incoming webpage from the webhost before it reaches web browser 408. Web browser add-on 409's receipt of the incoming webpage may trigger web browser add-on 409 to request the user restrictions file. This request may be made directly to the backend or to application 406. In embodiments where the request is made to application 406, the application may return the local copy of the user restrictions file that is stored in memory 415. In other embodiments, application may transmit the request for the user restrictions file to the backend. Web browser add-on 409 may receive the requested user restrictions file from one of the backend or application 406. The user restrictions file may include not only user stated restrictions and dislikes, but also machine learning algorithm predictions, if the user restrictions file is obtained from the backend.

Web browser add-on 409 may determine the content of both the received webpage and the user restrictions file. This determination may be made by reading and understanding the webpage and reading and understanding the user restrictions file. The process for reading and understanding a webpage may involve natural language processing and a semantics engine capable of understanding combinations of structured and unstructured data to derive understanding and context from the webpage content. The process for reading and understanding the user restrictions file may be more simplistic because application 406 may have created the file in a known format (i.e., structured data). Web browser add-on 409 may then compare the content of the received webpage to the user restrictions file. The goal of web browser add-on 409 in this comparison is to find content in the webpage that is disliked by the user or is the subject of a user restriction. The comparison may include finding content on the webpage that directly matches dislikes or restrictions in the user restrictions file. The comparison may also include finding content on the webpage that indirectly or tangentially matches dislikes or restrictions in the user restrictions file. A direct match, for example, may include a scenario where a user dislike in the restrictions file is apples and the webpage includes a product named apples, or with a product description that includes the word apples. Thus, in this example, web browser add-on 409 would match the word “apple.” An indirect or tangential match, for example, may include a scenario where a user dislike in the restrictions file is apples and the webpage includes a food product called “gala” or “granny smith” and web browser add-on 409 infers that these products are apples or are related to apples based on the context of the product description, even if the word “apple” is not present. The context may be case sensitive but in this example, could include the fact that the products were listed under a “fruits” category heading, or simply listed with other foods. Other contexts may exist.

Web browser add-on 409 may then filter out undesired content from the received webpage. Undesired content may be the content matching any of the user restrictions and/or dislikes in the user restrictions file. In other embodiments, web browser add-on 409 may determine undesired content by ranking restrictions and/or dislikes in the user restrictions file, or by ranking the direct and indirect matches. In this embodiment, direct matches may receive a heavier weighting, and therefore a higher ranking than indirect matches. Indirect matches may be weighted and ranked based on the confidence of the indirect match. The confidence of the indirect match may be based on the strength and number of the contextual clues leading to the identification of an indirect match. In some embodiments, undesired content is determined by setting a threshold for the ranking of direct and indirect matches where results ranked at or above the threshold are considered undesired and results under the ranking threshold are not considered undesired. The removal of undesired content from the received webpage results in a filtered webpage. The filtered webpage is then displayed to the user via user interface 420. The display of the filtered webpage may be as a result of web browser add-on 409 returning the filtered webpage to web browser 408 and then web browser 408 displaying the webpage, or simply web browser add-on 409 directly displaying the webpage to the user.

Web browser add-on 409 may monitor the user's interactions with the filtered webpage through user interface 420. User interactions may include selecting various goods or services by clicking on those goods or services. User interactions may also include a user scrolling past results and possibly clicking on subsequent pages without selecting goods or services displayed on the filtered webpage. User interactions may further include user engagement which may be measured by the time spent viewing any portion of the filtered webpage and/or hovering a mouse over an area of the webpage such as hovering over a product or service. These user interactions may be recorded and packaged as a data set. The user interactions data set may be sent to the backend either directly from web browser add-on 409 or through application 406.

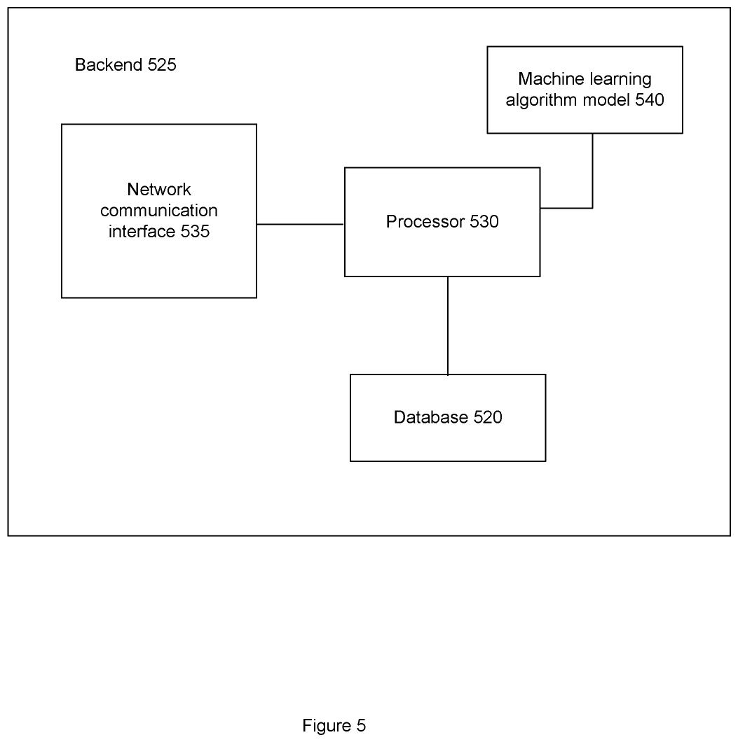

With reference to FIG. 5, backend 525 may be a server such as a dedicated server computer, such as bladed servers, or personal computer, laptop computer, notebook computer, palm top computer, network computer, or any processor-controlled device capable of supporting the system 100. While FIG. 5 illustrates a backend 525 that may be a single server, it is understood that other embodiments can use multiple servers or multiple computer systems as necessary or desired to support the users and can also use back-up or redundant servers to prevent network downtime in the event of a failure of a particular server. In a particular embodiment illustrated in FIG. 5, backend 525 includes a processor 530 in communication with a database module 520, a network communication interface 535, and a machine learning algorithm module 540. The processor 530 may include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The database 520 may comprise memory and can be a read-only memory, write-once read-multiple memory or read/write memory, e.g., RAM, ROM and EEPROM, and the user device 405 can include one or more of these memories.

The network communication interface 535 is configured to establish and support wired and/or wireless data communication capability for connecting the user device 405 to the network 110 or other communication network. The network communication interface 535 can also be configured to support communication with a short-range wireless communication interface, such as Bluetooth.

In embodiments of the invention, the processor 530 may receive a user restrictions file over network 110, via network communication interface 535. Processor 530 may send the user restrictions file to Database 520 for storage, and may also send the user restrictions file to machine learning algorithm 540 for use in predicting additional user restrictions and/or dislikes. Machine learning algorithm may use the user restrictions file, as well as additional inputs to predict additional user restrictions and dislikes. Processor 530 may receive the predicted user restrictions and/or dislikes and incorporate those into the user restrictions file, thereby creating an updated user restrictions file. The updated user restrictions file may be stored in database 520.

Responsive to a request, processor 530 may also send the updated user restrictions file to a web browser add-on for a web browser, running on a user device. Backend 525 may also receive, from the user device, data comprising one or more user actions taken in connection with a given webpage. This user interaction data may be stored in database 520, and may further be provided as feedback to machine learning algorithm 540. Machine learning algorithm 540 may use the feedback to determine the accuracy of the predicted user restrictions and/or dislikes, and further train the machine learning algorithm for improved, accuracy and computer efficiency.

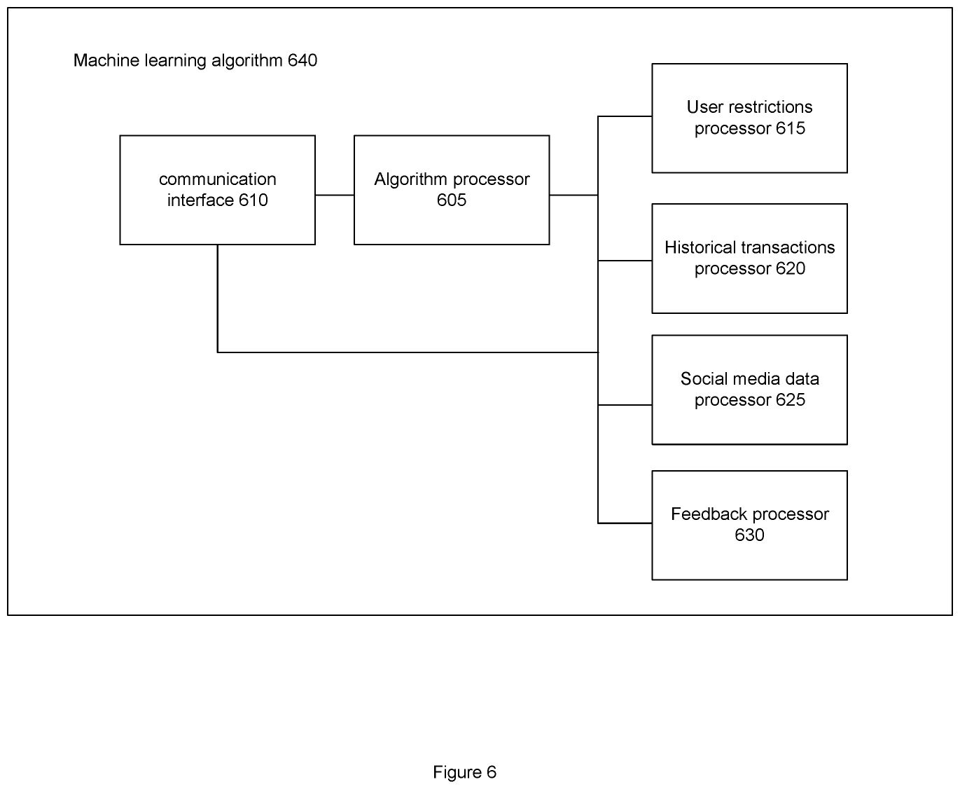

With reference to FIG. 6, machine learning algorithm 640 may be part of backend 525, and may predict user restrictions and dislikes. Machine learning algorithm 640 may include a communication interface 610 as well as an algorithm processor 605 coupled to a plurality of additional processors including user restrictions processor 615, historical transactions processor 620, social media data processor 625, and feedback processor 630. The processors of FIG. 6 may include microprocessors and associated processing circuitry, and can contain additional components, including processors, memories, error and parity/CRC checkers, data encoders, anticollision algorithms, controllers, command decoders, security primitives and tamper-proofing hardware, as necessary to perform the functions described herein.

Machine learning algorithm 640 may receive a number of inputs from the backend through communication interface 610. These inputs may include a user restrictions file that includes user restrictions and/or dislikes, historical transactions data, social media data, and algorithm feedback data. The historical transactions data may include both historical transactions for a user as well as historical transactions for a pool or group of users. Social media data may include data scrapped from a user's potentially numerous social media webpages. The scrapped data may include user interaction data such as user engagement with various posts, stories, topics, pictures, brands, etc. The social media data may also include a user's reported likes, clicks, dislikes as well as posts made by the user as well as replies by the user to other posts. Social media data may also track a user's interaction with advertisements on social media sites. Feedback data may include selecting various goods or services by clicking on those goods or services. Feedback data may also include a user scrolling past results and possibly clicking on subsequent pages without selecting goods or services displayed on the filtered webpage. Feedback data may further include user engagement which may be measured by the time spent viewing any portion of the filtered webpage and/or hovering a mouse over an area of the webpage such as hovering over a product or service.

User restrictions processor 615 may read the user restrictions file to understand the content of the restrictions and dislikes. This may include referencing a semantics engine capable of providing meaning, associations, and context to the restrictions and dislikes. User restrictions processor 615 may also parse the data in the user restrictions file to determine any relationships between and among the restrictions and dislikes. Historical transactions processor 620 may consider a user's historical transactions to determine any relationships between those past purchase or transactions and any of the restrictions and dislikes in the user restrictions file. The historical transactions processor 620 may put together a hierarchical structure of elements pulled from the historical transactions data for comparison against the content of the user restrictions file. Historical transactions processor 620 may also consider a larger pool of historical transaction data for differing users. This larger pool of historical transactions data may be useful for inferring restrictions and dislikes from a larger sampling of data. For instance, the larger data set may indicate that users who often buy product A rarely buy product B, but the specific user's transaction history is insufficient to draw this conclusion. In this example, the historical transaction processor 620 may infer that the user also dislikes product B or some characteristic or ingredient found in that product. The system may extrapolate what it is about product B that the user may dislike and therefore apply that dislike to other products.

Social media data processor 625 may leverage the user interaction data to infer relationships between those interactions and potential restrictions or dislikes. For example, if social media user interaction data includes a user giving a thumbs down to a post about a person's meal at a steakhouse restaurant, the social media data processor 625 may attempt to make inferences from that data. Inferences may include that the user does not like steakhouses, does not like the particular restaurant in the social media post, does not like the type of steak in the post, is vegan, etc. The social media processor may make multiple inferences from a given piece of social media data and may cross reference that data with other pieces of information. For example, if the user has a historical transaction at a steakhouse, then the social media data processor 625 may eliminate an inference that the user dislikes steakhouses and focus on other potential inferences. Another example is if the user “likes” a post about a person's meal at a steakhouse restaurant, then the social media data processor 625 may infer that the user dislikes vegetarian or vegan elements. These inferences may be cross-referenced against other data available to the machine learning algorithm 640. These inferences may also be weighted based on the existence of context and data supporting the inference.

Feedback processor 630 may leverage user interactions data regarding a filtered webpage provided from a user device. The user interactions data may include user engagement with various parts of the filtered webpage and may provide context or clues as to the accuracy of the predictions made by machine learning algorithm 640. For example, if a user interacts with a filtered webpage by quickly scrolling through the page before moving to subsequent result pages on the filtered webpage, or moving to a different webpage altogether, then feedback processor 630 may infer that the predicted restrictions and/or dislikes were not accurate. Feedback processor 630 may weigh this result against the likelihood that the page was simply the result of a user search that did not reveal a desired result generally, or any other cause of the user interaction that is not necessarily indicative of a poor performing algorithm. Feedback processor 630 may consider other contextual clues to properly understand the user interaction data and the importance/weight of that data. In another example, if a user selects one or more products from the filtered webpage and then completes a purchase of one or more of those products, the algorithm may infer that the predictions of dislikes and/or restrictions was accurate. This inference may also be weighed based on available contextual clues to protect against the possibility that the purchase is agnostic to the predicted restrictions and dislikes and therefore does not support a positive feedback inference.

Maintaining a robust feedback loop for training machine learning algorithm 640 and improving the function of a server associated with the backend may be difficult as content is filtered from a webpage. In a standard filtering arrangement, there will not be the opportunity for direct feedback as the user cannot interact with content that has been removed from a webpage. This leaves only the opportunity to make inferences based on user interactions with the remaining content and context that helps machine learning algorithm 640 understand those user interactions. However, in other embodiments, the system may not entirely remove filtered content from a user's view. For example, the filtered webpage may simply “grey out” filtered material thereby sending a signal to the user that the content is disfavored, but still allowing for the user to interact with the content, such as clicking on the greyed-out content and purchasing a product associated with that content. This approach would provide the opportunity for stronger, and in some instances direct feedback to machine learning algorithm 640 via feedback processor 630. In another embodiment filtered content may not be removed entirely from the filtered webpage, but instead may be made smaller or otherwise minimized. Another approach is to reorder results on the webpage such that filtered content is placed at the end of a list so that it is primarily removed from the user's view, but not entirely removed. Other embodiments may also take a time-based approach to filtering such that greyed out content becomes fainter over time as the user does not interact with the content, and then eventually is removed entirely from the filtered webpage. If a user interacts with greyed out content, the content may become more distinct or cease being greyed out, and this interaction data may be passed to the feedback processor 630 as a negative inference. The foregoing are examples of how the user interaction data and approaches to filtering may be used to enhance feedback to machine learning algorithm 640, and are not meant to be exhaustive.

Each of the component processors 615-630 provide data to algorithm processor 605. In turn, algorithm processor 605 may make predictions regarding additional user restrictions and/or dislikes. The predictions by the algorithm processor 605 may be developed by one or more machine learning algorithms and generated by one or more predictive models. In an embodiment, the machine learning algorithms employed can include at least one selected from the group of gradient boosting machine, logistic regression, neural networks, and a combination thereof, however, it is understood that other machine learning algorithms can be utilized.

The predictive models described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real-valued weight. Nodes may either be (i) input nodes (e.g., receiving data from outside the network), (ii) output nodes (e.g., yielding results), or (iii) hidden nodes (e.g., that may modify the data en route from input to output). RNNs may accept an input vector x and give an output vector y. However, the output vectors are based not only by the input just provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

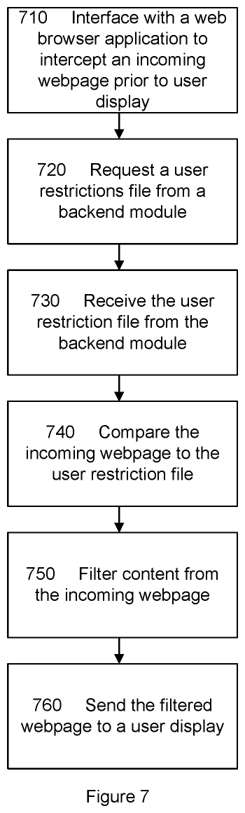

FIG. 7 illustrates an exemplary method for implementing an active web-based content filtering system according to an embodiment of the invention. The actions of the method depicted in FIG. 7 may be carried out by a user device and may result in the delivery and display of a filtered webpage where undesired content has been removed. At step 710, a web browser add-on may piggy-back on a web browser and intercept an incoming webpage that was requested by a user on a user device. The incoming webpage may be intercepted before it is displayed to the user. At step 720, the web browser add-on my request a user restrictions file. This user restrictions file may be stored locally on the user device. In this scenario, the web browser add-on may simply access the user restrictions file in a memory of the user device. In another embodiment, the web browser add-on may operate in conjunction with an application, and request for the user restrictions file may flow through the application to the user device memory. In yet another embodiment, the user restrictions file request may be sent to a backend associated with the web browser add-on, the application, or both. At step 730, the web browser add-on may receive the user restrictions file from the backend via a network. The received user restrictions file may be received by the application and forwarded to the web browser add-on or directly received by the web browser add-on.

At step 740, the web browser add-on may compare the user restrictions file to the intercepted webpage. The comparison requires understanding the content of both the webpage and the user restrictions file. Understanding the webpage may be accomplished by implementing NPL and image recognition/processing software on the webpage and further implementing a semantics engine that ascribes/derives meaning and context to the language and images on the webpage. The user restrictions file may exist in a known format, and therefore, may be more easily understood by the web browser add-on. The comparison may include scanning the intercepted webpage for restrictions and/or dislikes parsed from the user restrictions file. For example, if the user restrictions file includes gummy bears as a dislike, the comparison may scan the webpage for the phrase “gummy bears.” This may be considered a form of direct matching. The comparison also may look for indirect matches. For example, if gluten is included as a dislike in the user restrictions file, then the web browser add-on may scan the webpage for the word “gluten.” However, the scanning may also appreciate that the absence of the word “gluten,” many products may still contain gluten. The web browser add-on may understand that bread and other carbohydrate-heavy food products often contain gluten, and may consider those products as indirect matches. Other forms and scenarios of direct and indirect matching may be possible.

At step 750, the web browser add-on may filter content from the intercepted webpage. Filtering content from the intercepted webpage may entail removing content that is perceived as undesired by the user requesting the webpage. The perception of undesired content may be driven by the matches resulting from the comparison in step 740. In one embodiment, all direct and indirect matches resulting from the comparison are considered undesired content and filtered by the web browser add-on. In another embodiment, the system my implement a weighting and ranking framework for the indirect matches. The indirect matches may be based on some number of degrees of abstraction from a restriction or dislike in the user restrictions file which may result in differing confidence levels for each indirect match. The weighting and ranking results may be based on the confidence level of the match, where a higher confidence may result in a higher ranking. In this scenario, a threshold ranking may be set where matches at or above that threshold are considered to be undesired content and those matches below the threshold are not filtered from the intercepted webpage. Filtering content from the intercepted webpage may include formatting the resulting webpage. For instance, the intercepted webpage has a visual format and removing content from that webpage changes the visual format. In the most basic sense, removing material leaves portions of the webpage with dead space or white space (i.e., no content). This could lead to a webpage with apparent holes or gaps which may be visually displeasing or even difficult to navigate. In some embodiments, the web browser add on may attempt to reformat the webpage after removing undesired content. The reformatting may take different forms. For example, in the event of product listing like on an Amazon.com search results page, the reformatting may simply move products “up” in the order to fill in blank spaces left by products that were removed. The reformatting may also include reordering product results. The reordering may be based on any number of criteria, one such criteria being the weighting of indirect matches in comparison step 740. For instance, if a product is part of an indirect match that fell below the threshold for removal, then it may be reordered to appear lower in the product listings than a product that was not on the indirect match ranking. Other criteria may be considered as the basis for reformatting the intercepted webpage. The result of removing undesired content and potentially reformatting the webpage is a filtered webpage. This filtered webpage is displayed to the user, on the user device's interactive user display, at step 760.

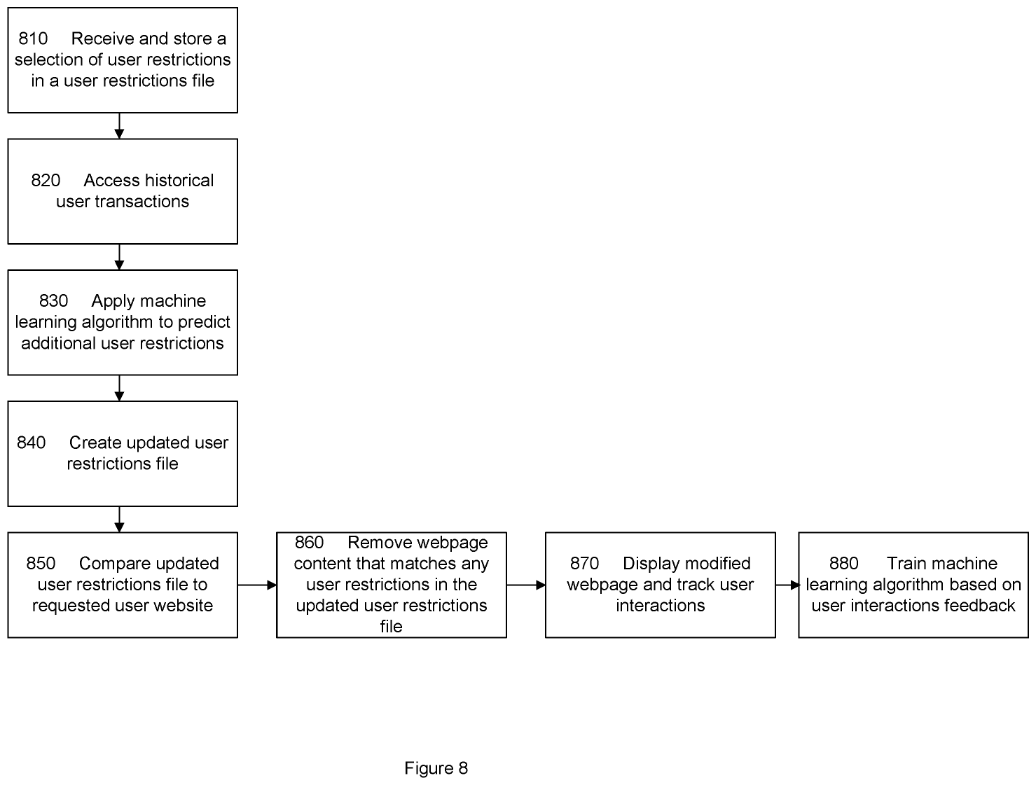

FIG. 8 illustrates an exemplary method for implementing an active web-based content filtering system according to an embodiment of the invention. The actions of the method depicted in FIG. 7 may be carried out by a backend and may result in the delivery and display of a filtered webpage where undesired content has been removed. At step 810, the backend may receive a user restrictions file from a user device. The user restrictions file may be created by a web browser add-on associated with the backend and running on the user device, or by an application associated with the backend and also running on the user device. The backend may store the user restrictions file in a database or in memory. In step 820, the backend may access historical transactions data for the user of the user device. This historical transactions data may be stored in the backend database or memory. The backend may also access historical transaction data for a group of other consumers to create a larger data set. The historical user transactions data may be segregated from the larger data set or included with the larger data set in order to help facilitate various types of data analysis. In some embodiments, the machine learning algorithm may receive additional inputs such as user data scraped from social media websites or other social media interfaces. The scrapped user data from social media may include posts made by the user, responses to posts made by others, discussions including the user, user likes, user dislikes, user interaction with social media content, lack of user interaction with social media content, etc.

At step 830, the backend may implement a machine learning algorithm in order to predict one or more additional user restrictions and/or dislikes. In an embodiment, the machine learning algorithm may determine one or more relationships between products and user stated restrictions or dislikes in the user restrictions file. For instance, a k-nearest neighbors (“KNN”) algorithm may be used associate and cluster similar products and product features, characteristics, ingredients, etc. For example, gummy candies may be grouped together to include gummy bears, gummy worms, gummies, etc. Then specific ingredients such as sugar, food coloring, etc. or characteristics such as “candy,” “soft,” “sweet,” etc. may be associated with the cluster. Furthermore, clusters may be linked through common ingredients, characteristics, or other commonalities. By way of example, the machine learning algorithm may predict that if a user dislikes gummy bears, he or she will also dislike soft cookies, oatmeal, soda with a common food coloring, etc. The machine learning algorithm may consider other contextual data to make these predictions, or to improve the confidence in the predictions. The machine learning algorithm may also rely on stated dislikes and restrictions from other users in conjunction with a user restriction file to help predict user dislikes and restrictions for a given user. Machine learning algorithm 326 may utilize a system of weights and ranks for the predictions based on a confidence in the prediction. The confidence in a prediction may be based on the number of commonalities of characteristics, ingredients, etc. to a user stated restriction or dislike, or based on affirming feedback based on one or more prior predictions. Machine learning algorithm 326 may be trained to better predict user dislikes and restrictions by analyzing across all users.

At step 840, the backend may create an updated user restrictions file. The updated user restrictions file may include the original restrictions and/or dislikes as well as the predicted one or more additional restrictions and/or user dislikes from the machine learning algorithm. The updated restrictions file may be stored in the backend database or memory.

At step 850, the updated user restrictions file may be compared against a user requested webpage. The details of this step are similar to those described in relation to step 740 of FIG. 7. At step 860, content that matches restrictions or dislikes in the updated user restrictions file may be removed from the requested webpage. The details of this step are similar to those described in relation to step 750 of FIG. 7.

In step 870, the filtered webpage is presented to the user and the user's interactions with that filtered webpage may be monitored and recorded. The user's interactions may include selecting various goods or services by clicking on those goods or services. User interactions may also include a user scrolling past results and possibly clicking on subsequent pages without selecting goods or services displayed on the filtered webpage. User interactions may further include user engagement which may be measured by the time spent viewing any portion of the filtered webpage and/or hovering a mouse over an area of the webpage such as hovering over a product or service. The user device may send the collected user interactions to the backend via the web browser add-on or the associated application. The backend may store the user interactions data in the database or memory and at step 880, may send the data to the machine learning algorithm as feedback to train, further refine, and improve the machine learning algorithm. The user interactions data may help train machine learning algorithm in a variety of different ways. For example, if a user selects one or more products from the filtered webpage and then completes a purchase of one or more of those products, the algorithm may infer that the predictions of dislikes and/or restrictions was accurate. However, user interactions that tend to indicate dissatisfaction, such as low user engagement with the filtered webpage, scrolling through the webpage or accessing additional pages in a listing of products (i.e., a desired product was not one of the first results in the filtered webpage). If the filtered webpage is delivered to the user without reformatting (i.e., with blank spaces where removed content was initially) and the user seeks to view the removed content, then this may also be inferred as negative feedback. In another embodiment, viewing the removed content may be inferred as neutral, but it a user then selects a product that was filtered, that data may be inferred as negative feedback. The foregoing are examples of how the user interaction data may be used as feedback to the machine learning algorithm and are not meant to be exhaustive. With continued feedback and training of the machine learning algorithm over time, the machine learning algorithm may not only become more accurate, but also more efficient as there is less computing necessary as the machine learning algorithm becomes more confident of restrictions and dislikes predictions. Thus, not only is the accuracy of the predictions improved over time, but the functioning of the computer is also improved over time as the machine learning algorithm is trained.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

The foregoing description, along with its associated embodiments, has been presented for purposes of illustration only. It is not exhaustive and does not limit the invention to the precise form disclosed. Those skilled in the art may appreciate from the foregoing description that modifications and variations are possible in light of the above teachings or may be acquired from practicing the disclosed embodiments. For example, the steps described need not be performed in the same sequence discussed or with the same degree of separation. Likewise various steps may be omitted, repeated, or combined, as necessary, to achieve the same or similar objectives. Accordingly, the invention is not limited to the above-described embodiments, but instead is defined by the appended claims in light of their full scope of equivalents.

1. An active web-based content filtering system, comprising:
a user device in communication with a backend server, the user device comprising:
a memory for storing a user restrictions file received from the backend server, the user restrictions file comprising one or more user dislikes;
an interactive user interface; and
a processor, the processor implementing a web browser add-on configured to:
receive an incoming webpage based on a user input;
parse content from the incoming webpage using natural language processing and a semantics engine to derive understanding and context from the parsed content;
request, over a network, the user restrictions file from the backend server;
receive the user restrictions file;
extract the one or more user restrictions and/or dislikes from the user restrictions file;
determine undesired incoming webpage content by comparing each of the extracted user restrictions and dislikes with the parsed content from the incoming webpage to determine if each user restriction or dislike directly or indirectly matches the extracted content, where a direct match relies on similarity of words and an indirect match is based on contextual relationships between words;
create a filtered webpage comprising: removal of the undesired incoming webpage content and blank spaces where undesired incoming website content was removed; and
display the filtered webpage to the user.

2. The active web-based content filtering system of claim 1, wherein the system operates fully on a user device.

3. The active web-based content filtering system of claim 1, wherein the web browser add-on is installed on a web browser in a user device.

4. The active web-based content filtering system of claim 1, wherein the extracted content comprises information about one or more goods or services.

5. The active web-based content filtering system of claim 1, wherein the determination of one or more matches between the extracted content and one or more of the one or more user dislikes includes an analysis of the extracted content for natural language and context.

6. The active web-based content filtering system of claim 5, wherein the language and context of the extracted content are parsed for specific words that match any of the one or more user dislikes.

7. The active web-based content filtering system of claim 6, wherein the determination of one or more matches between the extracted content and one or more of the one or more user dislikes also considers one or more tangential relationships between the parsed language and context of the extracted content and the one or more user dislikes.

8. The active web-based content filtering system of claim 1, wherein the user restrictions file is based, at least in part, on one or more historical user transactions.

9. The active web-based content filtering system of claim 8, further comprising:
a predictive model, wherein the predictive model is configured to dynamically update the user restrictions file by evaluating a plurality of relationships for one or more products based on the historical user transactions and user-stated dislikes in order to predict at least one additional user dislike.

10. The active web-based content filtering system of claim 9, wherein the predictive model is updated based on feedback from the user input and one or more user interactions with the filtered webpage.

11. A method of active web-based content filtering, comprising:
receiving, by a processor, an incoming webpage based on a user input;
parsing, by the processor, content from the incoming webpage using natural language processing and a semantics engine to derive understanding and context from the parsed content;
requesting, over a network, a user restrictions file from a backend server, the user restrictions file comprising one or more user dislikes;
receiving, by the processor, the user restrictions file;
extracting the one or more user restrictions and/or dislikes from the user restrictions file;
determining, by the processor, undesired incoming webpage content by comparing each of the extracted user restrictions and dislikes with the parsed content from the incoming webpage to determine if each user restriction or dislike directly or indirectly matches the extracted content, where a direct match relies on similarity of words and an indirect match is based on contextual relationships between words;
creating, by the processor, a filtered webpage comprising: removal of the undesired incoming webpage content and blank spaces where undesired incoming website content was removed; and
displaying, by the processor, the filtered webpage to the user.

12. The method of claim 11, wherein the method operates fully on a user device.

13. The method of claim 11, wherein the extracted content comprises information about one or more goods or services.

14. The method of claim 11, wherein the determination of one or more matches between the extracted content and one or more of the one or more user dislikes includes an analysis of the extracted content for natural language and context.

15. The method of claim 14, wherein the language and context of the extracted content are parsed for specific words that match any of the one or more user dislikes.

16. The method of claim 15, wherein the determination of one or more matches between the extracted content and one or more of the one or more user dislikes also considers one or more tangential relationships between the parsed language and context of the extracted content and the one or more user dislikes.

17. The method of claim 11, wherein the user restrictions file is based, at least in part, on one or more historical user transactions.

18. The method of claim 17, further comprising:
dynamically updating, via a predictive model, the user restrictions file by evaluating a plurality of relationships for one or more products based on the historical user transactions and user-stated dislikes in order to predict at least one additional user dislike.

19. The method of claim 18, wherein the predictive model is updated based on feedback from the user input and one or more user interactions with the filtered webpage.

20. A computer-readable non-transitory medium comprising computer-executable instructions that, when executed by at least one processor, perform procedures comprising:
receiving, by a processor, an incoming webpage based on a user input;
parsing, by the processor, content from the incoming webpage using natural language processing and a semantics engine to derive understanding and context from the parsed content;
requesting, over a network, a user restrictions file from a backend server, the user restrictions file comprising one or more user dislikes;
receiving, by the processor, the user restrictions file;
extracting the one or more user restrictions and/or dislikes from the user restrictions file;
determining, by the processor, undesired incoming webpage content by comparing each of the extracted user restrictions and dislikes with the parsed content from the incoming webpage to determine if each user restriction or dislike directly or indirectly matches the extracted content, where a direct match relies on similarity of words and an indirect match is based on contextual relationships between words;
creating, by the processor, a filtered webpage comprising: removal of the undesired incoming webpage content and blank spaces where undesired incoming website content was removed; and
displaying, by the processor, the filtered webpage to the user.
